(19) United States
(12) Patent Application Publication
(10) Pub. No.: US 2023/0327362 A1
(43) Pub. Date: Oct. 12, 2023

(54) SURFACE MOUNT CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroki KOBAYASHI, Mie (JP); Shinji NOZAKI, Mie (JP)

(21) Appl. No.: 18/023,964

(22) PCT Filed: Jul. 29, 2021
(86) PCT No.: PCT/JP2021/028046

§ 371 Date: Feb. 28, 2023

(30) Foreign Application Priority Data
Sep. 9, 2020 (JP) 2020-151244

(51) Int. Cl. H01R 13/506; H01R 13/405; H01R 12/71

(52) U.S. Cl. CPC H01R 13/506; H01R 13/405; H01R 12/716

(57) ABSTRACT

A surface mount connector 10 is to be mounted on a circuit board 5 having a plate thickness direction oriented in a vertical direction, and provided with a plurality of terminals 11, a plurality of inner housings 20 for holding the plurality of terminals 11, and an outer housing 30 for accommodating the plurality of inner housings 20 in parallel. Leads 13 to be connected to the circuit board 5 are provided on lower end parts of the plurality of terminals 11. Each of the plurality of inner housings 20 is supported independently movably in the vertical direction in the outer housing 30.

### TECHNICAL FIELD

The present disclosure relates to a surface mount connector.

### BACKGROUND

A surface mount connector is provided with leads to be connected to a wiring pattern on a board by solder. To reliably connect a plurality of the leads to the board, lower end parts of the plurality of leads need to be substantially aligned and arranged on a board surface. That is, the coplanarity (flatness) of the leads needs to be ensured. Further, even if the coplanarity of the leads is satisfactory, the connection of the leads and the board may become defective, for example, if the board is warped during reflow soldering.

A surface mount connector described in Japanese Unexamined Patent Publication No. 2010-146728 (Patent Document 1 below) is conventionally known as a surface mount connector for solving the above problem. This surface mount connector is provided with contacts and an insulating housing for holding the contacts. The contact includes a springy movable portion and a lead to be connected to a printed wiring board by soldering, and the lead is disposed below a standoff of the insulating housing. In mounting the surface mount connector on the printed wiring board, the leads and the printed wiring board can be satisfactorily connected by deflecting the movable portions of the contacts.

### PRIOR ART DOCUMENT

### Patent Document

Patent Document 1: JP 2010-146728 A

### SUMMARY OF THE INVENTION

### Problems to be Solved

However, in the above configuration, the surface mount connector needs to be pressed downward to deflect the movable portions at the time of mounting. Further, since a configuration for restricting movements of the movable portions is not provided, there is a possibility that the movable portions are not only deflected in a vertical direction, but also shifted in a lateral direction, and the surface mount connector may not be properly mounted.

### Means to Solve the Problem

The present disclosure is directed to a surface mount connector to be mounted on a circuit board having a plate thickness direction oriented in a vertical direction, the surface mount connector including a plurality of terminals, a plurality of inner housings for holding the plurality of terminals, and an outer housing for accommodating the plurality of inner housings in parallel, leads to be connected to the circuit board being provided on lower end parts of the plurality of terminals, and each of the plurality of inner housings being supported independently movably in the vertical direction in the outer housing.

### Effect of the Invention

According to the present disclosure, it is possible to provide a surface mount connector capable of suppressing a connection failure of leads and a circuit board due to the warping of the circuit board or the like.

### BRIEF DESCRIPTION OF THE DRAWINGS

FIG. 1 is a perspective view of a surface mount connector according to an embodiment.

FIG. 2 is a plan view of the surface mount connector.

FIG. 3 is a section along A-A of FIG. 2.

FIG. 4 is a section along B-B of FIG. 3.

FIG. 5 is a section along C-C of FIG. 4.

FIG. 6 is a perspective view in section along A-A of FIG. 2 of an outer housing.

FIG. 7 is a perspective view of an inner housing holding terminals.

FIG. 8 is a back view of the surface mount connector mounted on a horizontal circuit board.

FIG. 9 is a section along D-D of FIG. 8.

FIG. 10 is a back view of the surface mount connector mounted on a circuit board warped to be convex downward.

FIG. 11 is an enlarged view of FIG. 10 showing a downward warpage amount of the circuit board.

FIG. 12 is a section along E-E of FIG. 10.

FIG. 13 is a back view of the surface mount connector mounted on a circuit board warped to be convex upward.

FIG. 14 is an enlarged view of FIG. 13 showing an upward warpage amount of the circuit board.

FIG. 15 is a section along F-F of FIG. 13.

### DETAILED DESCRIPTION TO EXECUTE THE INVENTION

### Description of Embodiments of Present Disclosure

First, embodiments of the present disclosure are listed and described.

(1) The surface mount connector of the present disclosure is a surface mount connector to be mounted on a circuit board having a plate thickness direction oriented in a vertical direction, and includes a plurality of terminals, a plurality of inner housings for holding the plurality of terminals, and an outer housing for accommodating the plurality of inner housings in parallel, leads to be connected to the circuit board being provided on lower end parts of the plurality of terminals, and each of the plurality of inner housings being supported independently movably in the vertical direction in the outer housing.

According to this configuration, each of the plurality of inner housings holding the terminals independently moves in the vertical direction in accordance with the warpage of the circuit board, whereby a state where the leads and the circuit board are in contact can be secured. Therefore, a connection failure of the leads and the circuit board can be suppressed.

(2) Preferably, the plurality of inner housings include locking projections projecting toward the outer housing, the outer housing includes lower locking portions to be locked to the locking projections from below, the plurality of inner housings are prevented from coming out downward from the outer housing by locking the locking projections and the lower locking portions, a position in the vertical direction where the plurality of inner housings are disposed when the outer housing is fixed on the horizontal circuit board is a reference position, and first clearances are set in the vertical direction between the locking projections and the lower locking portions at the reference position.

According to this configuration, since the first clearances are set in the vertical direction between the locking projections and the lower locking portions at the reference position, the inner housings can move downward, following the circuit board, if the circuit board is warped to be convex downward, and a connection failure of the leads and the circuit board is easily suppressed.

(3) Preferably, the outer housing includes a peg for fixing the outer housing on the circuit board.

According to this configuration, the position in the vertical direction of the outer housing with respect to the circuit board can be changed by changing a length in the vertical direction of the peg projecting downward from the lower end of the outer housing. Therefore, the sizes of the first clearances can be changed.

(4) Preferably, the outer housing includes upper locking portions to be locked to upper surfaces of the plurality of inner housings from above, the plurality of inner housings are prevented from coming out upward from the outer housing by locking the upper locking portions and the upper surfaces of the plurality of inner housings, and second clearances are set in the vertical direction between the upper surfaces of the plurality of inner housings and the upper locking portions at the reference position.

According to this configuration, since the second clearances are set in the vertical direction between the upper surfaces of the inner housings and the upper locking portions at the reference position, the inner housings can move upward, following the circuit board, if the circuit board is warped to be convex upward, and a connection failure of the leads and the circuit board is easily suppressed.

(5) Preferably, the plurality of inner housings include guide portions extending in the vertical direction and projecting toward the outer housing, the outer housing includes guide recesses extending in the vertical direction and to be engaged with the guide portions, and each of the plurality of inner housings is guided to independently move in the vertical direction by engaging the guide portions and the guide recesses.

According to this configuration, the inner housings easily move in the vertical direction.

(6) Preferably, upper surfaces of the guide portions are provided to be flush with the upper surfaces of the inner housings and the upper locking portions are lockable to the upper surfaces of the guide portions from above.

According to this configuration, since locking parts of the inner housings and the upper locking portions become large, the inner housings can be further suppressed from coming out upward from the outer housing.

(7) Preferably, a pair of the locking projections and a pair of the guide portions are respectively provided on both sides of the inner housing in a direction orthogonal to the vertical direction and an arrangement direction of the plurality of inner housings.

According to this configuration, the inner housing can be further suppressed from coming out upward and downward from the outer housing, and more easily moves in the vertical direction. Further, dimensions of the inner housing and the outer housing in the arrangement direction of the plurality of inner housings can be reduced.

(8) Preferably, the inner housing holds a plurality of the terminals.

According to this configuration, the multipole surface mount connector is easily configured.

(9) Preferably, the outer housing includes a receptacle open upward and is connected to a mating connector as a connection partner from below.

According to this configuration, since a connecting direction of the surface mount connector and the mating connector is the vertical direction and coincides with a direction, in which the inner housings are movable, the connection of the surface mount connector and the mating connector is hardly hindered even if the plurality of inner housings independently move in the vertical direction.

### Details of Embodiment of Present Disclosure

Hereinafter, an embodiment of the present disclosure is described. The present disclosure is not limited to these illustrations, but is represented by claims and intended to include all changes in the scope of claims and in the meaning and scope of equivalents.

### Embodiment

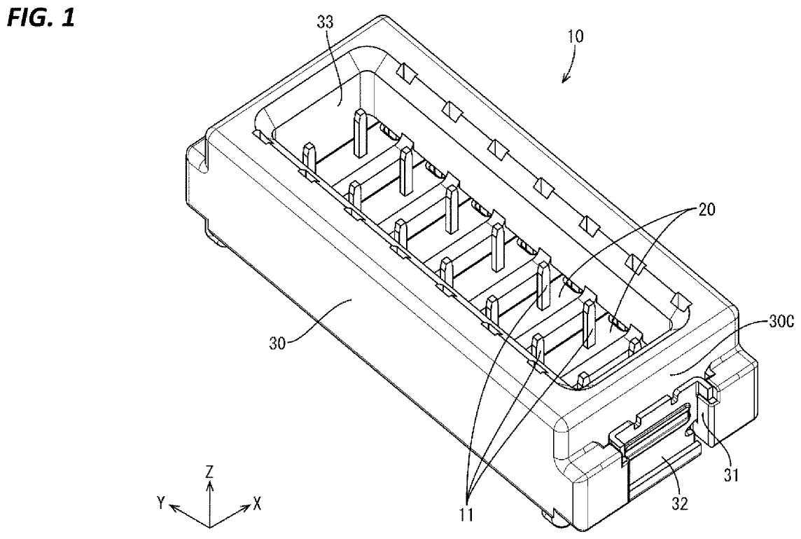

The embodiment of the present disclosure is described with reference to FIGS. 1 to 15. In the following description, a direction indicated by an arrow Z is referred to as an upward direction, a direction indicated by an arrow X is referred to as a forward direction, and a direction indicated by an arrow Y is referred to as a leftward direction. Note that, for a plurality of identical members, only some members may be denoted by a reference sign and the other members may not be denoted by the reference sign.

[Surface Mount Connector]

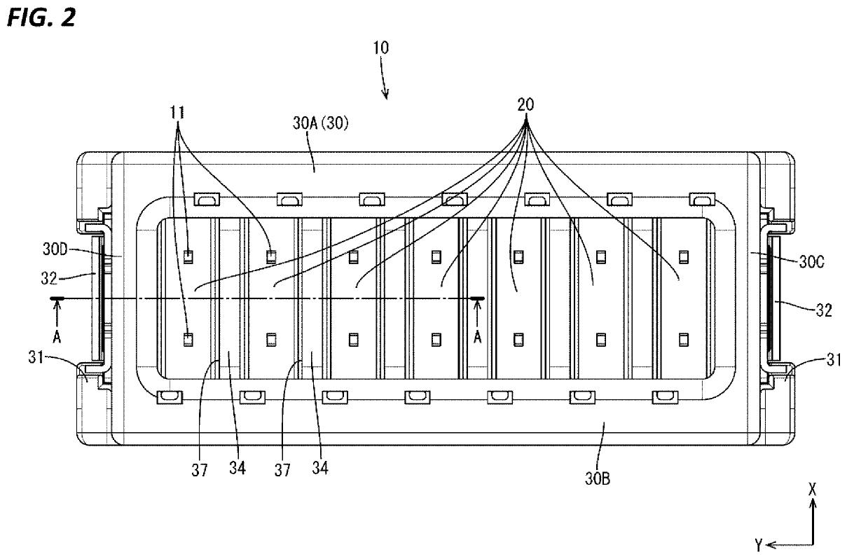

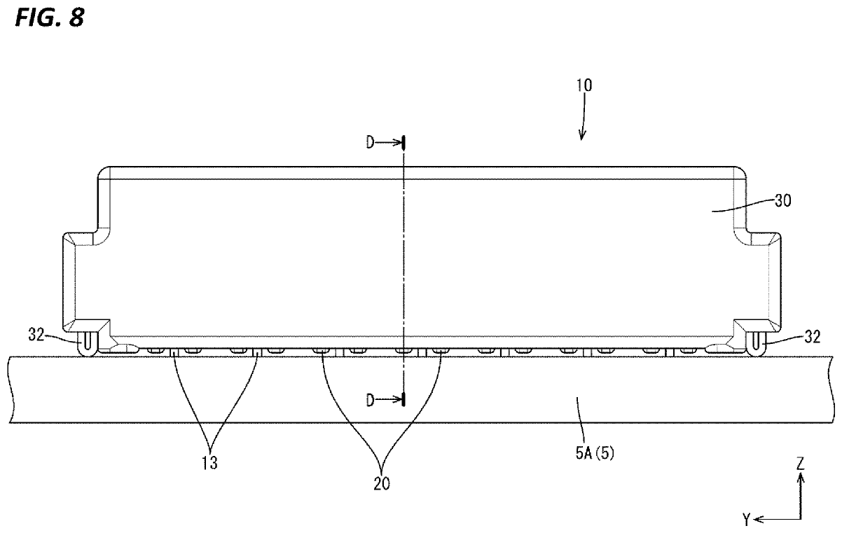

A surface mount connector 10 of this embodiment is, for example, installed in a vehicle or the like and is, as shown in FIGS. 1 and 2, provided with a plurality of terminals 11, a plurality of (seven in this embodiment) inner housings 20 each for holding a pair of the terminals 11 and an outer housing 30 for accommodating the plurality of inner housings 20 in parallel. In this embodiment, an arrangement direction of the plurality of inner housings 20 is a lateral direction. As shown in FIG. 8, the surface mount connector 10 is mounted on a circuit board 5 having a plate thickness direction oriented in a vertical direction, and connected to a mating connector (not shown) as a connection partner from below.

[Terminals, Leads]

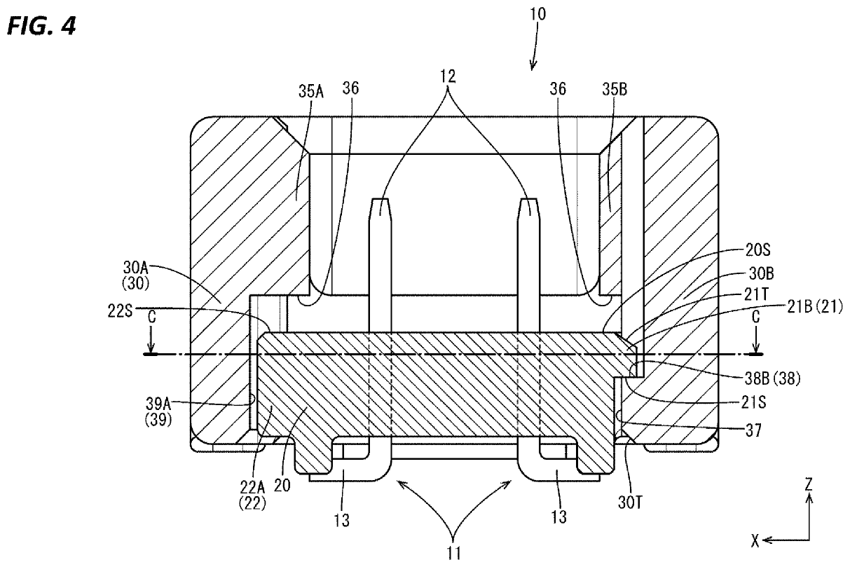

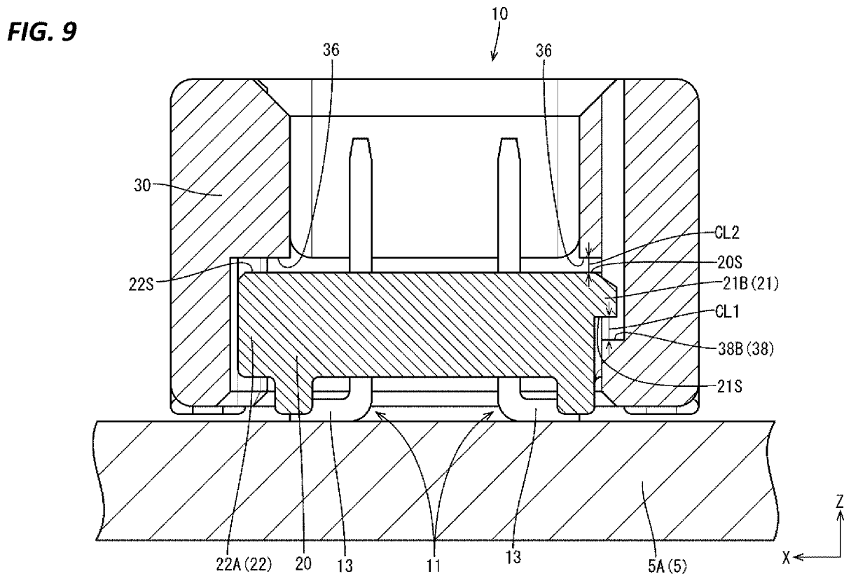

The terminal 11 is made of electrically conductive metal and includes, as shown in FIG. 4, a tab-shaped terminal connecting portion 12 projecting upward and a lead 13 extending forward or rearward on a lower end part. The lead 13 is electrically connected to a conductive path (not shown) on the circuit board 5 by soldering (see FIG. 9).

[Inner Housing, Locking Projections]

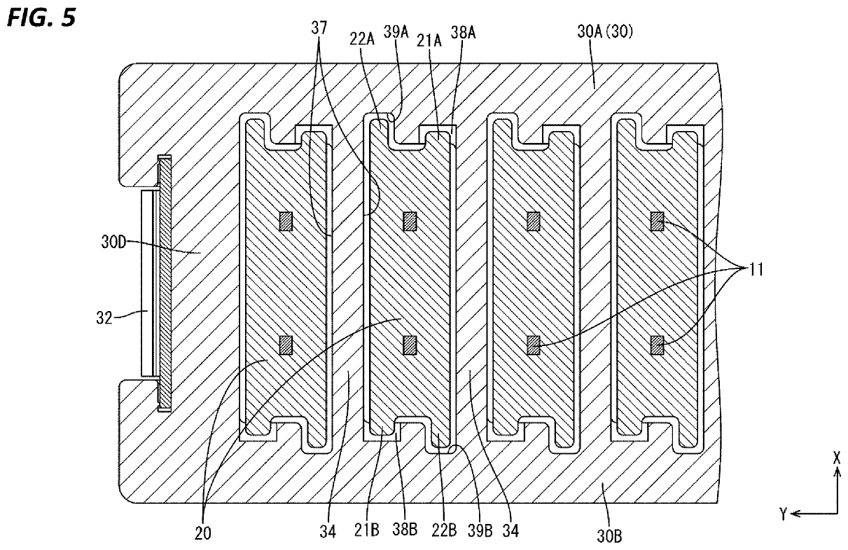

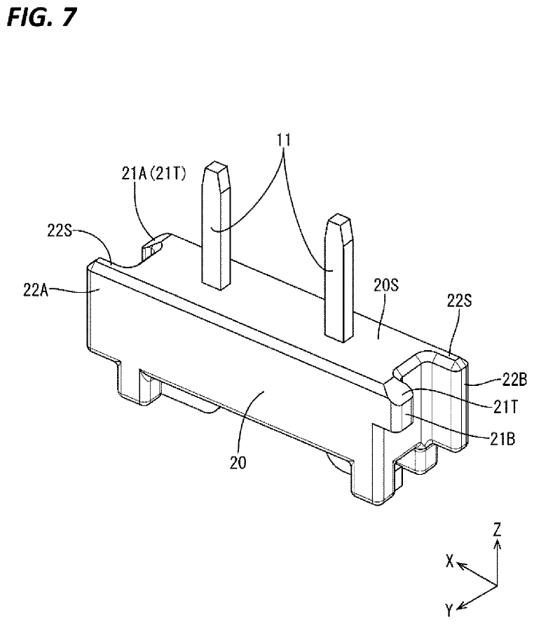

The inner housing 20 is made of insulating synthetic resin and, as shown in FIG. 7, block-like. The inner housing 20 holds the pair of terminals 11 arranged in a front-rear direction. The terminals 11 are press-fit into or insert-molded with the inner housing 20 and integrated with the inner housing 20. As shown in FIG. 4, the lead 13 of the terminal 11 disposed on a front side of the inner housing 20 extends forward, and the lead 13 of the terminal 11 disposed on a rear side of the inner housing 20 extends rearward. As shown in FIG. 7, a locking projection 21A projecting forward is provided on a right side of the front surface of the inner housing 20, and a locking projection 21B projecting rearward is provided on a left side of the back surface of the inner housing 20. That is, as shown in FIG. 5, the inner housing 20 has a point-symmetrical cross-sectional shape in a plan view. With the inner housing 20 accommodated in the outer housing 30, the locking projections 21A, 21B project toward the outer housing 30. As shown in FIG. 7, inclined surfaces 21T inclined to approach the outer housing 30 toward a lower side are provided on upper parts of the locking projections 21A, 21B. As shown in FIG. 4, a lower surface 21S of the locking projection 21B is parallel to a horizontal plane. Although not shown, the locking projection 21B also has a similar lower surface 21S. In the following description, the pair of locking projections 21A, 21B may be merely referred to as locking projections 21 without being distinguished.

[Guide Portions]

As shown in FIG. 7, a guide portion 22A extending in the vertical direction and projecting forward is provided on a left side of the front surface of the inner housing 20, and a guide portion 22B extending in the vertical direction and projecting rearward is provided on a right side of the back surface of the inner housing 20. Upper surfaces 22S of the guide portions 22A, 22B are provided to be flush with an upper surface 20S of the inner housing 20 and parallel to the horizontal plane. As shown in FIG. 5, with the inner housing 20 accommodated in the outer housing 30, the guide portions 22A, 22B project toward the outer housing 30. In the following description, the pair of guide portions 22A, 22B may be merely referred to as guide portions 22 without being distinguished.

[Outer Housing, Receptacle]

The outer housing 30 is made of insulating synthetic resin and, as shown in FIGS. 1 and 2, in the form of a box long in the lateral direction and open in the vertical direction. A right wall 30C and a left wall 30D of the outer housing 30 are provided with peg mounting portions 31, and pegs 32 made of a metal plate can be mounted and fixed in the peg mounting portions 31. As shown in FIG. 8, the outer housing 30 is fixed on the circuit board 5 by soldering the pegs 32 to fixing lands (not shown) on the circuit board 5. As shown in FIG. 1, the outer housing 30 includes a receptacle 33 open upward and receives the mating connector (not shown).

[Upper Locking Portions]

As shown in FIGS. 2 and 5, partition walls 34 connecting a front wall 30A and a rear wall 30B of the outer housing 30 are provided in parallel in the lateral direction inside the outer housing 30. An inner wall of the outer housing 30 constituted by the front wall 30A, the rear wall 30B and a pair of the partition walls 34 (including cases where one of the partition walls 34 is the right wall 30C or left wall 30D) serves as a peripheral wall 37. One inner housing 20 is accommodated inside the peripheral wall 37. As shown in FIG. 4, the front wall 30A of the outer housing 30 is provided with a projecting wall 35A projecting rearward, and the rear wall 30B of the outer housing 30 is provided with a projecting wall 35B projecting forward. With the inner housing 20 accommodated in the outer housing 30, the projecting walls 35A, 35B project toward the inner housing 20. The lower surfaces of the projecting walls 35A, 35B are parallel to the horizontal plane and serve as upper locking portions 36.

[Lower Locking Portions, Guide Recesses]

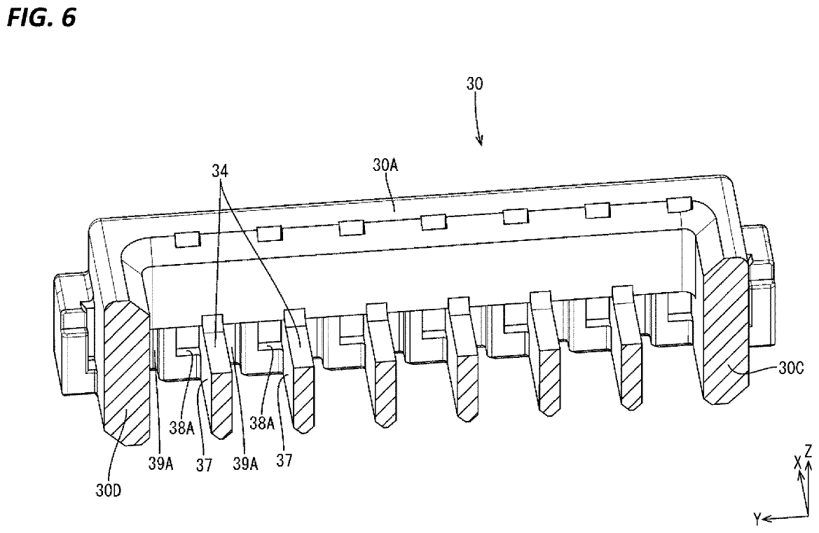

As shown in FIG. 6, the front wall 30A constituting the peripheral wall 37 is formed with lower locking portions 38A and guide recesses 39A. The lower locking portion 38A is disposed on a right side of the peripheral wall 37, and the guide recess 39A is disposed on a left side of the peripheral wall 37. As shown in FIG. 5, the rear wall 30B is also provided with lower locking portions 38B on left sides of the peripheral walls 37 and guide recesses 39B on right sides of the peripheral walls 37. That is, one peripheral wall 37 includes a pair of the lower locking portions 38A, 38B and a pair of the guide recesses 39A, 39B and is shaped point-symmetrically in a plan view.

As shown in FIG. 4, the lower locking portion 38B is located in a central part in the vertical direction of the peripheral wall 37 and disposed to face the lower surface 21S of the locking projection 21B of the inner housing 20 accommodated inside the peripheral wall 37. Although not shown in detail, the lower locking portion 38A is also similarly located in the central part in the vertical direction of the peripheral wall 37 and disposed to face the lower surface 21S of the locking projection 21A of the inner housing 20 accommodated inside the peripheral wall 37 (see FIG. 5). In the following description, the lower locking portions 38A, 38B may be merely referred to as lower locking portions 38 without being distinguished. As shown in FIGS. 4 and 6, the guide recess 39A is in the form of a groove extending in the vertical direction. As shown in FIG. 4, an upper end part of the guide recess 39A is connected to the lower surface (upper locking portion 36) of the projecting wall 35A. Although not shown, the guide recess 39B is also similarly provided.

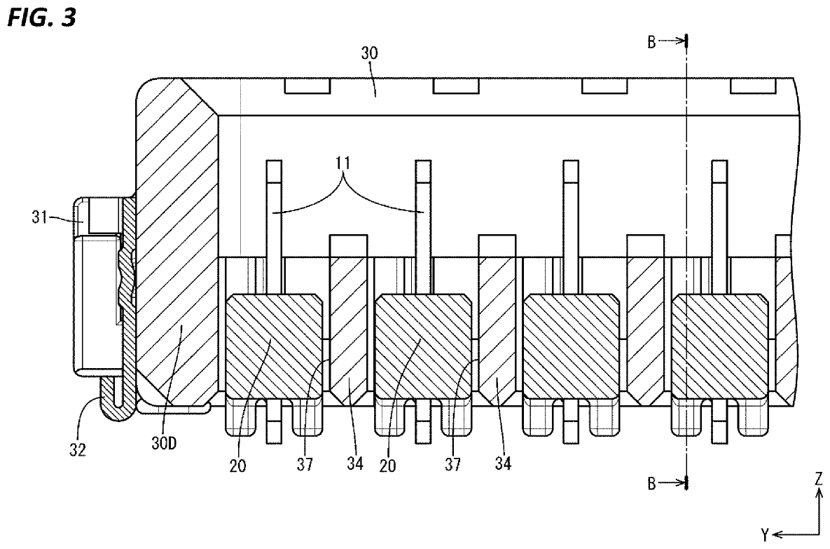

As shown in FIGS. 3 and 5, lateral side surfaces of the inner housings 20 and the peripheral walls 37 are flat surfaces and do not include any member for locking or engaging the inner housings 20 and the peripheral walls 37 in the lateral direction. In this way, lateral dimensions of the inner housings 20 and the outer housing 30 can be reduced.

The terminals 11, the inner housings 20 and the outer housing 30 are configured as described above. An example of an assembling method of the surface mount connector 10 is described below.

The plurality of inner housings 20 holding the terminals 11 are inserted into the outer housing 30 from below and accommodated inside the peripheral walls 37. As shown in FIG. 4, a guiding portion 30T inclined to be located on a more outer peripheral side toward the bottom is provided on an inner peripheral side of a lower end part of the outer housing 30. The inner housing 20 can be smoothly inserted into the outer housing 30 from below by the engagement of the guiding portion 30T of the outer housing 30 and the inclined surfaces 21T of the locking projections 21 of the inner housing 20. Further, as shown in FIG. 5, the guide portions 22A, 22B of the inner housing 20 are engaged with the guide recesses 39A, 39B of the outer housing 30 to guide the insertion of the inner housing 20 into the outer housing 30.

As the inner housing 20 is further inserted into the outer housing 30, the locking projections 21 of the inner housing 20 return to a natural state from a resiliently deformed state by being engaged with the front and rear walls 30A, 30B of the outer housing 30. That is, the lower surfaces 21S of the locking projections 21 are disposed above the lower locking portions 38, whereby the assembling of the surface mount connector 10 is completed (see FIG. 4).

As shown in FIG. 4, each of the plurality of inner housings 20 is supported independently movably in the vertical direction in the outer housing 30. That is, the inner housing 20 can move upward with respect to the outer housing 30 until the upper surface 20S of the inner housing 20 (and the upper surfaces 22S of the guide portions 22) are locked to the upper locking portions 36 of the outer housing 30. Further, the inner housing 20 can move downward with respect to the outer housing 30 until the lower surface 21S of the inner housing 20 is locked to the lower locking portions 38 of the outer housing 30. In FIG. 4, the lower surfaces 21S of the locking projections 21 are locked to the lower locking portions 38 by the own weight of the inner housing 20.

Next, a state where the surface mount connector 10 is fixed on the circuit board 5 is described with reference to FIGS. 8 to 15. As shown in FIG. 8, the surface mount connector 10 is mounted on the circuit board 5 by soldering the leads 13 and the pegs 32 to the circuit board 5. The surface mount connector 10 is soldered to the circuit board 5 by reflow soldering or the like.

[Horizontal Circuit Board, Reference Position, First Clearances, Second Clearances]

FIG. 8 is a back view of the surface mount connector 10 mounted on a horizontal circuit board 5A (an example of a circuit board). A position in the vertical direction where the plurality of inner housings 20 are disposed when the outer housing 30 is fixed on the horizontal circuit board 5A is a reference position shown in FIG. 9. As shown in FIG. 9, at the reference position, the leads 13 are in contact with the horizontal circuit board 5A and the inner housing 20 is supported above a locking position by the own weight shown in FIG. 4 with respect to the outer housing 30. That is, at the reference position, first clearances CL1 are set in the vertical direction between the lower surfaces 21S of the locking projections 21 and the lower locking portions 38. Further, at the reference position, second clearances CL2 are set in the vertical direction between the upper surfaces 20S of the plurality of inner housings 20 (and the upper surfaces 22S of the guide portions 22) and the upper locking portions 36.

As shown in FIG. 8, since the lower ends of the pegs 32 are located below the lower end of the outer housing 30 in this embodiment, the position in the vertical direction of the outer housing 30 with respect to the circuit board 5 is determined by lengths in the vertical direction of the pegs 32 projecting downward from the lower end of the outer housing 30. Therefore, by changing the lengths in the vertical direction of the pegs 32, the position in the vertical direction of the outer housing 30 with respect to the circuit board 5 can be changed and the first and second clearances CL1, CL2 can also be changed (see FIG. 9).

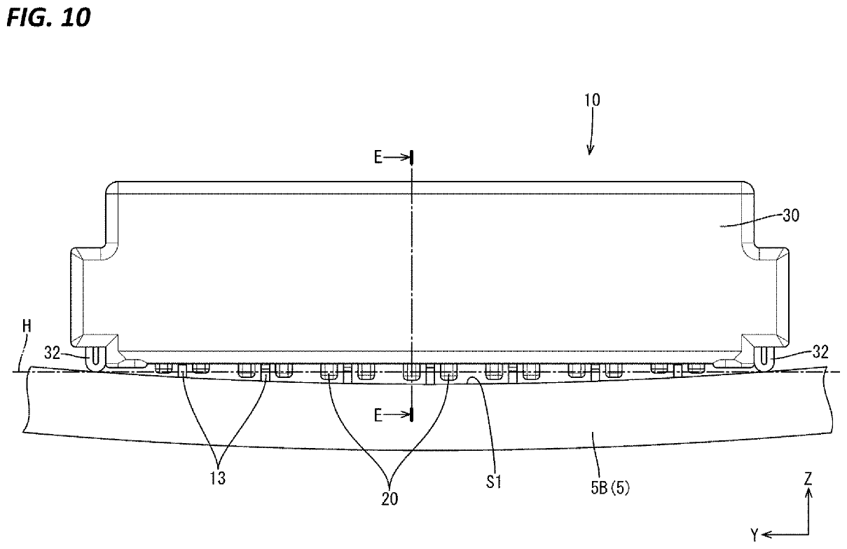

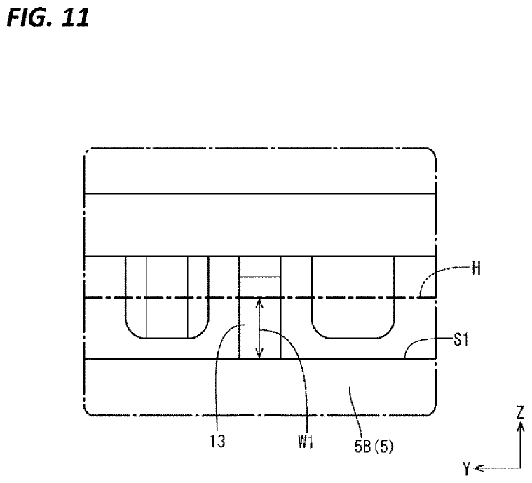

FIG. 10 is a back view of the surface mount connector 10 mounted on a circuit board 5B (an example of the circuit board) warped to be convex downward. It is assumed that the circuit board 5B is warped in the lateral direction, in which the inner housings 20 are arranged, but not warped in the front-rear direction. The circuit board 5B is not only the one thermally deformed during a reflow process, but also the one warped before the surface mount connector 10 is mounted. In FIG. 10, a dashed-dotted line connecting lower end parts of the pair of pegs 32 indicates a horizontal reference plane H, and a surface S1 of the circuit board 5B in a part where the leads 13 are mounted is located below the reference plane H. As shown in FIG. 11, a vertical distance between the reference plane H and the surface S1 of the circuit board 5B is defined as a downward warpage amount W1. The downward warpage amount W1 decreases toward the pegs 32 and is large at a center position in the lateral direction (see FIG. 10).

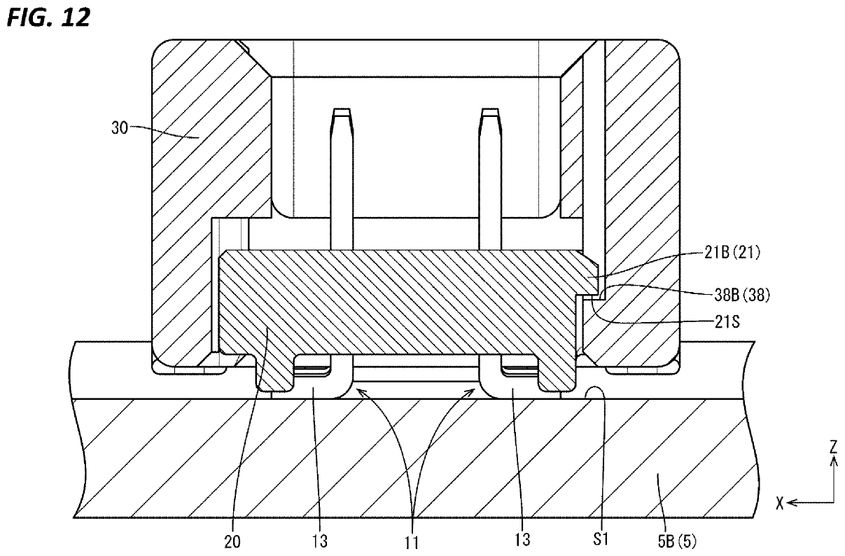

As shown in FIG. 12, the inner housing 20 moves to a position lower than the reference position of FIG. 9 by the own weight thereof since the circuit board 5B is convex downward. The inner housing 20 moves downward until the lower surfaces 21S of the locking projections 21 and the lower locking portions 38 are locked or the leads and the surface S1 of the circuit board 5B are brought into contact. Here, by setting the first clearances CL1 (see FIG. 9) equal to or larger than a maximum value of the downward warpage amount W1 (see FIG. 11), the leads 13 can be reliably brought into contact with the surface S1 of the circuit board 5B. Therefore, even if the circuit board 5B is warped to be convex downward, a soldering connection failure of the leads 13 and the circuit board 5B can be suppressed.

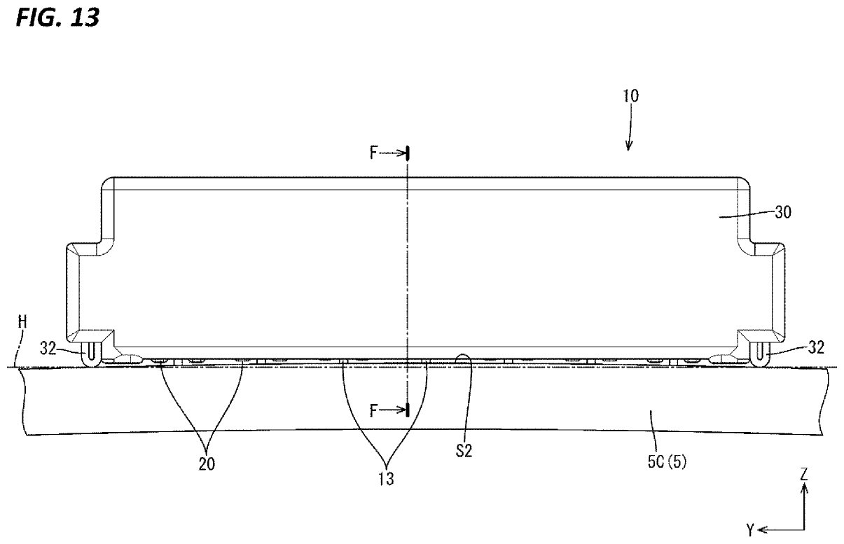

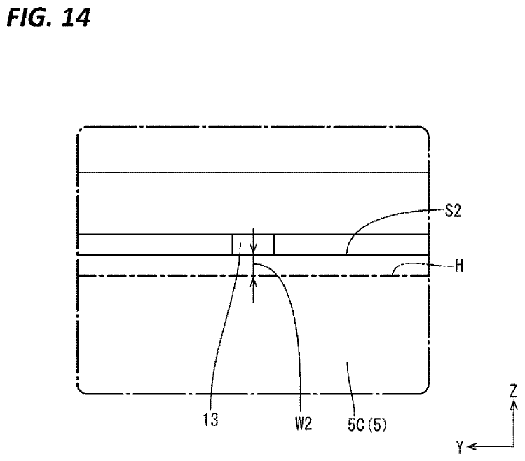

FIG. 13 is a back view of the surface mount connector 10 mounted on a circuit board 5C (an example of the circuit board) warped to be convex upward. It is assumed that the circuit board 5C is warped in the lateral direction, in which the inner housings 20 are arranged, but not warped in the front-rear direction. The circuit board 5C is not only the one thermally deformed during a reflow process, but also the one warped before the surface mount connector 10 is mounted. In FIG. 13, a dashed-dotted line connecting lower end parts of the pair of pegs 32 indicates a horizontal reference plane H, and a surface S2 of the circuit board 5C in a part where the leads 13 are mounted is located above the reference plane H. As shown in FIG. 14, a vertical distance between the reference plane H and the surface S2 of the circuit board 5C is defined as an upward warpage amount W2. The upward warpage amount W2 decreases toward the pegs 32 and is large at a center position in the lateral direction (see FIG. 13).

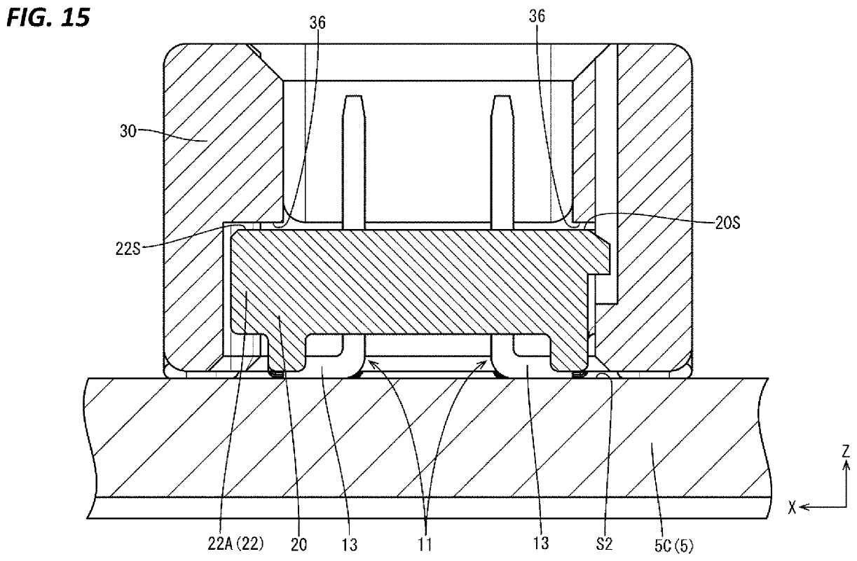

As shown in FIG. 15, the inner housing 20 moves to a position higher than the reference position of FIG. 9 by the contact of the circuit board 5C with the leads 13 since the circuit board 5C is convex upward. The inner housing 20 can move upward with respect to the outer housing 30 until the upper surface 20S of the inner housing 20 (and the upper surfaces 22S of the guide portions 22) and the upper locking portions 36 are locked. Here, by setting the second clearances CL2 (see FIG. 9) equal to or larger than a maximum value of the upward warpage amount W2 (see FIG. 14), the outer housing 30 can be prevented from being pushed up by the inner housings 20 even if the circuit board 5C contacts the leads 13 and moves the inner housings 20 upward. In this way, it can be suppressed that the outer housing 30 moves upward and the pegs 32 and the leads 13 disposed near the pegs 13 are separated from the circuit board 5C (see FIG. 13). Further, it can be prevented that a load of the outer housing 30 is applied to the leads 13 in contact with the circuit board 5C near the center position. Therefore, even if the circuit board 5C is warped to be convex upward, a soldering connection failure of the leads 13 and the circuit board 5C can be suppressed.

[Functions and Effects of Embodiment]

According to this embodiment, the following functions and effects are achieved.

The surface mount connector 10 according to this embodiment is mounted on the circuit board 5 having the plate thickness direction oriented in the vertical direction, and is provided with the plurality of terminals 11, the plurality of inner housings 20 for holding the plurality of terminals 11 and the outer housing 30 for accommodating the plurality of inner housings 20 in parallel, the leads 13 to be connected to the circuit board 5 are provided on the lower end parts of the plurality of terminals 11, and each of the plurality of inner housings 20 is supported independently movably in the vertical direction in the outer housing 30.

According to the above configuration, each of the plurality of inner housings 20 holding the terminals 11 independently move in the vertical direction in accordance with the warpage of the circuit board 5, whereby a contact state of the leads 13 and the circuit board 5 can be secured. Therefore, a connection failure of the leads 13 and the circuit board 5 can be suppressed.

In this embodiment, the plurality of inner housings 20 include the locking projections 21A, 21B projecting toward the outer housing 30, the outer housing 30 includes the lower locking portions 38A, 38B to be locked to the locking projections 21A, 21B from below, the plurality of inner housings 20 are prevented from coming out downward from the outer housing 30 by locking the locking projections 21A, 21B and the lower locking portions 38A, 38B, the position in the vertical direction where the plurality of inner housings 20 are disposed when the outer housing 30 is fixed on the horizontal circuit board 5A is the reference position, and the first clearances CL1 are set in the vertical direction between the locking projections 21A, 21B and the lower locking portions 38A, 38B at the reference position.

According to the above configuration, since the first clearances CL1 are set in the vertical direction between the locking projections 21A, 21B and the lower locking portions 38A, 38B at the reference position, the inner housings 20 can move downward, following the circuit board 5B, if the circuit board 5B is warped to be convex downward, and a connection failure of the circuit board 5B and the leads 13 is easily suppressed.

In this embodiment, the outer housing 30 includes the pegs 32 for fixing the outer housing 30 on the circuit board 5.

According to this configuration, the position in the vertical direction of the outer housing 30 with respect to the circuit board 5 can be changed by changing the lengths in the vertical direction of the pegs 32 projecting downward from the lower end of the outer housing 30. Therefore, the sizes of the first clearances CL1 can be changed.

In this embodiment, the outer housing 30 includes the upper locking portions 36 to be locked to the upper surfaces 20S of the plurality of inner housings 20 from above, the plurality of inner housings 20 are prevented from coming out upward from the outer housing 30 by locking the upper locking portions 36 and the upper surfaces 20S of the plurality of inner housings 20, and the second clearances CL2 are set in the vertical direction between the upper surfaces 20S of the plurality of inner housings 20 and the upper locking portions 36 at the reference position.

According to the above configuration, since the second clearances CL2 are set in the vertical direction between the upper surfaces 20S of the plurality of inner housings 20 and the upper locking portions 36 at the reference position, the inner housings 20 can move upward, following the circuit board 5C, if the circuit board 5C is warped to be convex upward, and a connection failure of the circuit board 5C and the leads 13 is easily suppressed.

In this embodiment, the plurality of inner housings 20 include the guide portions 22A, 22B extending in the vertical direction and projecting toward the outer housing 30, the outer housing 30 includes the guide recesses 39A, 39B extending in the vertical direction and to be engaged with the guide portions 22A, 22B, and each of the plurality of inner housings 20 is guided to independently move in the vertical direction by engaging the guide portions 22A, 22B and the guide recesses 39A, 39B.

According to the above configuration, the inner housings 20 easily move in the vertical direction.

The upper surfaces 22S of the guide portions 22A, 22B are provided to be flush with the upper surfaces 20S of the inner housings 20, and the upper locking portions 36 can be locked to the upper surfaces 22S from above.

According to the above configuration, since locking parts of the inner housings 20 and the upper locking portions 36 become large, the inner housings 20 can be further suppressed from coming out upward from the outer housing 30.

In this embodiment, the pair of locking projections 21A, 21B and the pair of guide portions 22A, 22B are provided on both sides of the inner housing 20 in the direction (front-rear direction) orthogonal to the vertical direction and the arrangement direction of the plurality of inner housings 20.

According to the above configuration, the inner housings 20 can be further suppressed from coming out upward and downward from the outer housing 30, and the inner housings 20 more easily move in the vertical direction. Further, dimensions of the inner housings 20 and the outer housing 30 in the arrangement direction (lateral direction) of the plurality of inner housings 20 can be reduced.

In this embodiment, the inner housing 20 holds the plurality of terminals 11.

According to the above configuration, the multipole surface mount connector 10 is easily configured.

In this embodiment, the outer housing 30 includes the receptacle 33 open upward and is connected to the mating connector as the connection partner from below.

According to the above configuration, a connecting direction of the surface mount connector 10 and the mating connector is the vertical direction and coincides with a direction in which the inner housings 20 are movable. Thus, even if the plurality of inner housings 20 independently move in the vertical direction, the connection of the surface mount connector 10 and the mating connector is hardly hindered.

### Other Embodiments

(1) Although the outer housing 30 includes the receptacle 33 open upward and is connected to the mating connector from below in the above embodiment, there is no limitation to this. For example, an outer housing may include a receptacle open forward and connected to a mating connector from behind.

(2) Although the inner housing 20 includes the pair of locking projections 21A, 21B and the pair of guide portions 22A, 22B in the above embodiment, there is no limitation to this. The inner housing may include one, three or more locking projections and one, three or more guide portions. Further, the inner housing may not include any guide portion.

(3) Although the inner housing 20 includes the pair of terminals 11 in the above embodiment, there is no limitation to this. An inner housing may include one, three or more terminals.

(4) Although the terminal 11 is a tab-shaped male terminal in the above embodiment, there is no limitation to this. A terminal may be a tubular female terminal.

### LIST OF REFERENCE NUMERALS

5: circuit board

5A: horizontal circuit board

5B: circuit board warped to be convex downward

5C: circuit board warped to be convex upward

10: surface mount connector

11: terminal

12: terminal connecting portion

13: lead

20: inner housing

20S: upper surface of inner housing

21, 21A, 21B: locking projection

21S: lower surface of locking projection

21T: inclined surface of locking projection

22, 22A, 22B: guide portion

22S: upper surface of guide portion

30: outer housing

30A: front wall

30B: rear wall

30C: right wall

30D: left wall

30T: guiding portion

31: peg mounting portion

32: peg

33: receptacle

34: partition wall

35A, 35B: projecting wall

36: upper locking portion

37: peripheral wall

38, 38A, 38B: lower locking portion

39A, 39B: guide recess

CL1: first clearance

CL2: second clearance

H: reference plane

S1, S2: surface of circuit board

W1: downward warpage amount

W2: upward warpage amount

1. A surface mount connector to be mounted on a circuit board having a plate thickness direction oriented in a vertical direction, comprising:
a plurality of terminals;
a plurality of inner housings for holding the plurality of terminals; and
an outer housing for accommodating the plurality of inner housings in parallel,
leads to be connected to the circuit board being provided on lower end parts of the plurality of terminals, and
each of the plurality of inner housings being supported independently movably in the vertical direction in the outer housing.

2. The surface mount connector of claim 1, wherein:
the plurality of inner housings include locking projections projecting toward the outer housing,
the outer housing includes lower locking portions to be locked to the locking projections from below,
the plurality of inner housings are prevented from coming out downward from the outer housing by locking the locking projections and the lower locking portions,
a position in the vertical direction where the plurality of inner housings are disposed when the outer housing is fixed on the horizontal circuit board is a reference position, and
first clearances are set in the vertical direction between the locking projections and the lower locking portions at the reference position.

3. The surface mount connector of claim 2, wherein the outer housing includes a peg for fixing the outer housing on the circuit board.

4. The surface mount connector of claim 2, wherein:
the outer housing includes upper locking portions to be locked to upper surfaces of the plurality of inner housings from above,
the plurality of inner housings are prevented from coming out upward from the outer housing by locking the upper locking portions and the upper surfaces of the plurality of inner housings, and
second clearances are set in the vertical direction between the upper surfaces of the plurality of inner housings and the upper locking portions at the reference position.

5. The surface mount connector of claim 4, wherein:
the plurality of inner housings include guide portions extending in the vertical direction and projecting toward the outer housing,
the outer housing includes guide recesses extending in the vertical direction and to be engaged with the guide portions, and
each of the plurality of inner housings is guided to independently move in the vertical direction by engaging the guide portions and the guide recesses.

6. The surface mount connector of claim 5, wherein upper surfaces of the guide portions are provided to be flush with the upper surfaces of the inner housings and the upper locking portions are lockable to the upper surfaces of the guide portions from above.

7. The surface mount connector of claim 5, wherein a pair of the locking projections and a pair of the guide portions are respectively provided on both sides of the inner housing in a direction orthogonal to the vertical direction and an arrangement direction of the plurality of inner housings.

8. The surface mount connector of claim 1, wherein the inner housing holds a plurality of the terminals.

9. The surface mount connector of claim 1, wherein the outer housing includes a receptacle open upward and is connected to a mating connector as a connection partner from below.
